(19) United States
(12) Patent Application Publication
(10) Pub. No.: US 2024/0209770 A1
(43) Pub. Date: Jun. 27, 2024

(54) CYLINDER HEAD FOR AN INTERNAL COMBUSTION ENGINE AND AN INTERNAL COMBUSTION ENGINE WITH SUCH A CYLINDER HEAD

(71) Applicant: DEUTZ Aktiengesellschaft, Cologne (DE)

(72) Inventor: Benedikt Nork, Cologne (DE)

(21) Appl. No.: 18/544,728

(22) Filed: Dec. 19, 2023

(30) Foreign Application Priority Data
Dec. 23, 2022 (DE) 102022004897.3

(51) Int. Cl. F02B 23/10; F02B 15/00; F02B 31/06

(52) U.S. Cl. CPC F02B 23/104; F02B 15/00; F02B 31/06; F02B 2201/04

(57) ABSTRACT

A cylinder head for an internal combustion engine including a cylinder head arrangement having an intake port, an injector connected to the cylinder head arrangement, and a tubular injection tube extending along a tube core axis into the intake port and fluidly connected to the injector, an attachment element being arranged on the injection tube, and the attachment element having an air guiding portion which extends radially outwards with respect to the tube core axis in such a way that a flow in the intake port is influenced by the air guiding portion.

This claims the benefit of a German Patent Application DE 10 2022004897.3, filed on Dec. 23, 2022 which is hereby incorporated by reference herein.

The present disclosure relates to a cylinder head for an internal combustion engine and an internal combustion engine with such a cylinder head.

### BACKGROUND

The cylinder head of internal combustion engines delimits the combustion chambers on the side opposite the piston and regularly includes the intake and exhaust ports as well as the valve control for the gas exchange processes in the internal combustion engine. In engines with intake port injection, fuel is injected into the intake port such that a mixture of the fuel and the intake air is formed in the intake port.

### SUMMARY

An internal combustion engine with intake port injection is known from EP 0 694 124 B1, in which fuel is injected into the intake port via a tube.

At the end that opens into the intake port, the tube includes an atomizing screen that atomizes the fuel flowing out of the tube to improve mixture. This has the disadvantage that the atomizing screen can become clogged during continuous operation and the fuel supply is impaired. In addition, fuel can be retained in the tube by the atomizing screen, so that unintentional re-ignition can occur in the tube, especially when using hydrogen as fuel.

A cylinder head for an internal combustion engine is known from JP 2003 214 259 A, comprising: an intake port and an injector connected to the cylinder head. A tubular injection tube extends into the intake port and is fluidly connected to the injector. A C-shaped fastening ring and a collar element welded to the fastening ring are arranged in the intake port. The fastening ring is made of a spring material and is shaped such that it engages in a groove formed in the cylinder head body at the downstream end of the intake port.

WO 2019/147963 A1 discloses an injector with a nozzle head integrated into a cylinder head body. Inside the injection nozzle, fuel is mixed with air from an air supply of the injector before exiting the nozzle head.

Based on the above, the present disclosure is based on the task of providing a cylinder head for an internal combustion engine and an internal combustion engine with such a cylinder head, which enables a permanently favorable mixture in the intake port.

To solve the problem, a cylinder head for an internal combustion engine, in particular for a hydrogen-powered internal combustion engine, is proposed, comprising a cylinder head arrangement which includes an intake port, an injector which is connected to the cylinder head arrangement, and a tubular injection tube which extends along a tube core axis into the intake port and is fluidly connected to the injector, wherein an attachment element is arranged on the injection tube, and the attachment element having an air guiding portion which extends radially outwards with respect to the tube core axis in such a way that a flow in the intake port is influenced by the air guiding portion.

The radially outwardly projecting air guiding portion generates an increased turbulent flow in the intake air downstream of the air guiding portion, wherein the turbulent flow improves mixing of the intake air with the fuel injected into the intake port via the injection tube. Due to the radially outward extending of the air guiding portion, the injection tube is not blocked by the air guiding portion, so that the injection tube is neither clogged as operation progresses nor is fuel retained by it in the injection tube.

The intake port constitutes the concluding part of the engine's air induction system. The intake port connects the intake manifold with the combustion chamber and are opened and closed with the intake valves.

In principle, the injector is also functional without the injection tube. The injection tube shifts the point at which the fuel enters the flow in the intake port from the wall delimiting the intake port towards the center of the intake port. The injection tube must therefore be considered separately from the components of the injector that are necessary for its general function.

In a possible embodiment, a radial extension of the air guiding portion with respect to the tube core axis can be greater than an axial extension in the direction of the tube core axis.

In particular, the air guiding portion can be designed as an air baffle. Herein, the extension of the air guiding portion along a circumference around the tube core axis can be smaller than the radial extension with respect to the tube core axis.

In a further embodiment, the attachment element can have a first connecting portion with which the attachment element is arranged on the injection tube.

The air guiding portion can extend radially outwards from the first connecting portion in relation to the tube core axis.

An embodiment is possible in which the smallest cylindrical envelope of the first connecting portion, whose cylindrical axis is arranged coaxially to the tube core axis, has a smaller radius than the largest radial extend of the air guiding portion from the tube core axis.

In a further possible embodiment, the attachment element can have a second connecting portion which is in contact with a wall of the intake port. The first connecting portion and the second connecting portion can be connected to each other via the air guiding portion. Forces acting on the injection tube, for example inertia forces caused by external vibrations, can thus be supported on the wall of the intake port via the attachment element. This reduces the stress on the injection tube, particularly in a transition area to the injector, and increases the service life of the injection tube accordingly.

In a further possible embodiment, the injection tube can have an injection aperture that opens into the intake port. The attachment element can be arranged between the injector and the injection aperture.

In a further possible embodiment, the cylinder head can comprise a first valve that can selectively open and close a first combustion chamber inlet aperture of the intake port. The first valve can include a valve disc and a valve shaft that extends along a first valve axis. The injection aperture can be arranged at least in portions within a smallest cylindrical envelope of the valve disc of the first valve that is coaxial with the first valve axis. In other words, the injection aperture can be arranged within an imaginary cylinder defined by a base surface of the cylinder disc and the valve axis.

In an alternative embodiment, the cylinder head may comprise a first valve that can selectively open and close a first combustion chamber inlet aperture of the intake port, the first valve including a valve head and a valve shaft extending along a first valve axis, and a second valve that can selectively open and close a second combustion chamber inlet aperture of the intake port, the second valve including a valve head and a valve shaft extending along a second valve axis. In this case, the injection aperture can be arranged between a first imaginary plane, which is described by the first valve axis and a perpendicular to the tube core axis, and a second imaginary plane, in which the second valve axis is arranged, and which extends parallel to the first imaginary plane.

To solve the problem, also an internal combustion engine is proposed which comprises a cylinder head in a previously described configuration.

### BRIEF SUMMARY OF THE DRAWINGS

Possible embodiments of a cylinder head respectively of an internal combustion engine according to the present disclosure are explained below with reference to the figures.

FIG. 1 is a schematic representation of a partial sectional view of an internal combustion engine with a first cylinder head according to the present disclosure;

FIG. 2 is a front view of the first attachment element in FIG. 1;

FIG. 3 is a sectional view of the first attachment element along the sectional line IV-IV in FIG. 2;

FIG. 4 is a front view of the second attachment element in FIG. 1;

FIG. 5 is a sectional view of the second attachment element along the sectional line IV-IV in FIG. 4;

FIG. 6 is a schematic representation of a partial sectional view of an internal combustion engine with a second cylinder head according to the present disclosure.

### DETAILED DESRIPTION

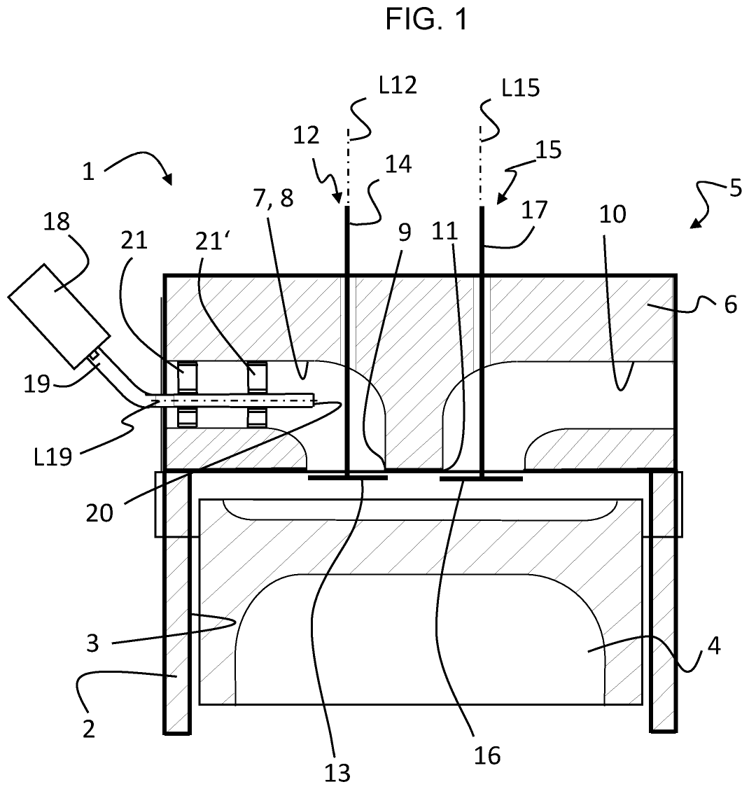

FIGS. 1 to 5, which are described together below, show an internal combustion engine 1. In particular, the internal combustion engine 1 is operated with hydrogen as fuel. The internal combustion engine 1 comprises a crankcase 2, which is connected to a cylinder head 5 according to the present disclosure.

In a known manner, the crankcase 2 comprises a variable combustion chamber 3, which is delimited by a movable piston 4 and the cylinder head 5. The cylinder head 5 comprises a cylinder head arrangement which includes a cylinder head base element 6 and a cylinder head cover, not shown, which are connected to one another.

An intake port 7 and an exhaust port 10 are cast into the cylinder head base element 6. An air-fuel mixture can be fed into the combustion chamber 3 via the intake port 7. The intake port 7 has a wall 8 respectively is delimited by the wall 8 and comprises a combustion chamber inlet aperture 9, which opens in the direction of the combustion chamber 3. The combustion chamber inlet aperture 9 can be selectively opened or closed in a known manner by an inlet valve 12. For this purpose, the inlet valve 12 comprises an inlet valve disc 13, which is arranged in a valve seat of the combustion chamber inlet aperture 9 when the combustion chamber inlet aperture 9 is to be closed, and an inlet valve shaft 14, which extends substantially cylindrically along a valve axis L12. The inlet valve 12 can be moved along the valve axis L12 by a corresponding valve train, which is arranged above the cylinder head base element 6.

The exhaust gases produced by the combustion of the air-fuel mixture in the combustion chamber 3 can flow out of the combustion chamber 3 via the outlet port 10. The outlet port 10 has a wall respectively is delimited by a wall and comprises a combustion chamber outlet aperture 11, which opens in the direction of the combustion chamber 3. The combustion chamber outlet aperture 11 can be opened or closed as desired in a known manner by an outlet valve 30. For this purpose, the exhaust valve 15 comprises an exhaust valve disc 16, which is arranged in a valve seat of the combustion chamber outlet aperture 11 when the combustion chamber outlet aperture 11 is to be closed, and an exhaust valve shaft 17, which extends substantially cylindrically along a valve axis L15. The exhaust valve 15 can be moved along the valve axis L15 by the valve train.

To form the mixture of air and fuel, fuel is injected into the intake port 7 via an injector 18, which is connected to the cylinder head arrangement, in particular to the cylinder head base element 6, via connecting means not shown. For this purpose, an outlet of the injector 18 is fluidly connected to an injection tube 19, which extends along a tube core axis L19 into the intake port 7. The injection tube 19 comprises an injection aperture 20, which opens into the intake port 7. In the present case, the injection tube 19 is formed angled and comprises a first straight end portion on the side of the injector 18 and a second straight end portion on the side of the injection aperture 20, which are connected to each other via a curved portion. The tube core axis L19 extends completely from one end of the injection tube 19 to the opposite end, whereby the tube core axis L19 is only shown in the area of the second end portion in FIG. 1 for the sake of clarity. It is also conceivable that the tube core axis can take on any other shape, such as being completely straight or S-shaped.

In the present case, the attachment element 20 is arranged inside an imaginary straight cylinder, wherein the base surface of the straight cylinder is described by the inlet valve disc 13 and extends along the valve axis L12.

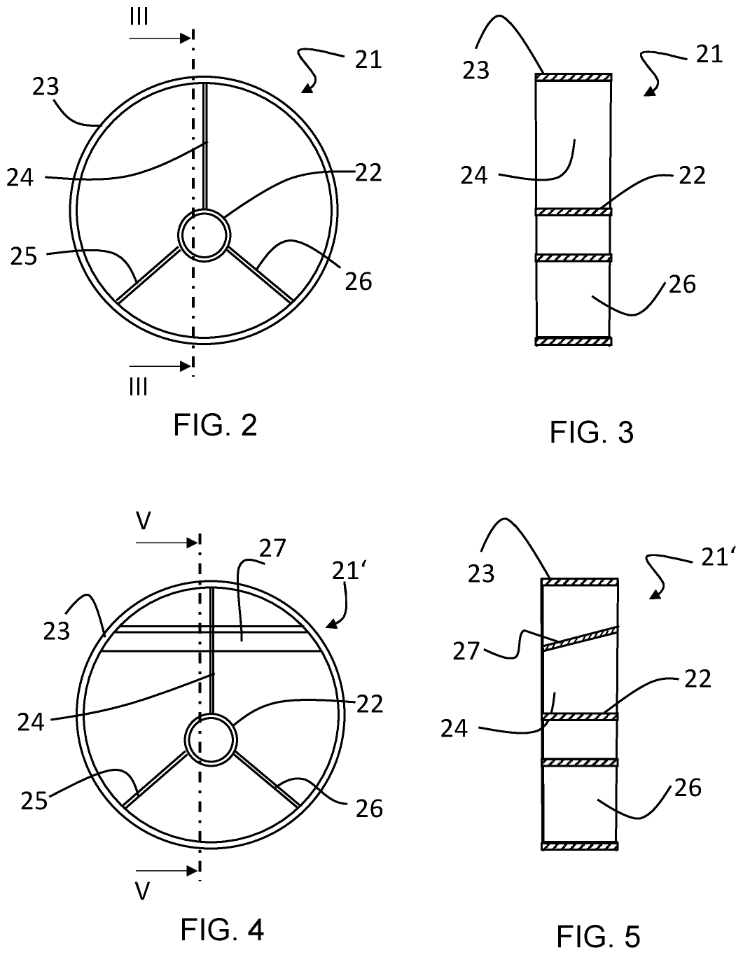

A first attachment element 21, which is shown in detail in FIGS. 2 and 3, and a second attachment element 21′, which is shown in detail in FIGS. 4 and 5, are seated on the injection tube 19 in the region of the second end portion. The first attachment element 21 and the second attachment element 21′ are each arranged between the injection aperture 20 of the injection tube 19 and the injector 18. Herein, the second attachment element 21′ is arranged along the tube core L19 closer to the injection aperture 20 than the first attachment element 21.

The first attachment element 21 comprises an annular first connecting portion 22, the inner contour of which is complementary to the outer contour of the injection tube 19. The first attachment element 21 and the second attachment element 21′ are firmly connected to the injection tube 19. In the present case, the first attachment element 21 and the second attachment element 21′ are press-fitted onto the injection tube 19. However, it is also conceivable that the two parts are joined in some other way, for example by soldering, gluing or pressing.

Starting from the first connecting portion 22, a first air guiding portion 24, a second air guiding portion 25 and a third air guiding portion 26 each extend radially outwards with respect to the tube core axis L19. The three air guiding portions 24, 25 and 26 each have a greater extension in the radial direction than in the axial direction with respect to the tube core L19. The air guiding portions 24, 25 and 26 each have a smaller extension in the circumferential direction around the tube core L19 than in the radial direction and/or axial direction and can accordingly be referred to as an air baffle. The air guiding portions 24, 25 and 26 are each shaped in such a way that the flow of intake air in the intake port 7 is influenced by them.

In the present case, the air guiding portions 24, 25 and 26 are designed as flat air guiding plates or air guiding baffles. However, the air guiding portions 24, 25 and 26 or air guiding baffles can also have a shape that differs from flat, for example they can be curved or twisted in the direction of the tube core L19. The flow of the intake air in the intake port can thus be set into a swirling and/or tumble motion by the air guiding portions 24, 25 and 26.

The first attachment element 21 further comprises an annular second connecting portion 23 which is in contact with a region of the wall 8 of the intake port 7. In this case, the second connecting portion 23 is press-fitted into the intake port 7. However, it is also conceivable here that the connecting portion 23 is joined to the wall 8 of the intake port 7 in another way.

The first connecting portion 22 and the second connecting portion 23 are firmly connected to each other via the air guiding portions 24, 25 and 26. The injection tube 19 is thus supported on the wall 8 of the intake port 7 via the first attachment element 21. This means that forces acting on the injection tube 19 can be supported by the attachment element 21, for example the inertial force of the injection tube 19 itself in the case of vibrations of the internal combustion engine 1. In this way, the stress on the injection tube 19 can be reduced and the service life of the injection tube 19 can be increased accordingly.

The second attachment element 21′ differs from the first attachment element 21 only in that a fourth air guiding portion 27 is provided in addition to the first air guiding portion 24, the second air guiding portion 25 and the third air guiding portion 26. In this respect, what was previously said with regard to the similarities in the context of the first attachment element 21 also applies analogously to the second attachment element 21′. Identical elements are marked with the same reference signs.

The fourth air guiding portion 27 is arranged at an angle respectively skewed to the tube core L19. Along the tube core axis L19, the fourth air guiding portion 27 is positioned at an angle relative to the tube core axis L19. Along the tube core L19, the distance between the fourth air guiding portion 27 and the tube core L19 is therefore different from constant. In particular, the distance between the fourth air guiding portion 27 and the tube core axis L19 increases evenly along the tube core L19.

The first attachment element 21 and the second attachment element 21′ thus influence the flow in the intake air in the intake duct 27 in such a way that the mixture is improved when the fuel is injected into the intake port 7. By arranging the two attachment elements 21, 21′ away from the injection aperture 20 of the injection tube 19, the cross-portion through which the fuel can flow from the injection tube 19 into the intake port 7 is not reduced, so that the flow of the fuel through the attachment elements 21, 21′ is not obstructed or the remaining cross-portion can become clogged with increasing operating time.

It is understood that any combination of first attachment elements 21 and second bottom elements 21′ can be provided instead of the two attachment elements 21, 21′, depending on the application. In particular, exactly one first attachment element 21 or one second attachment element 21′ can be provided.

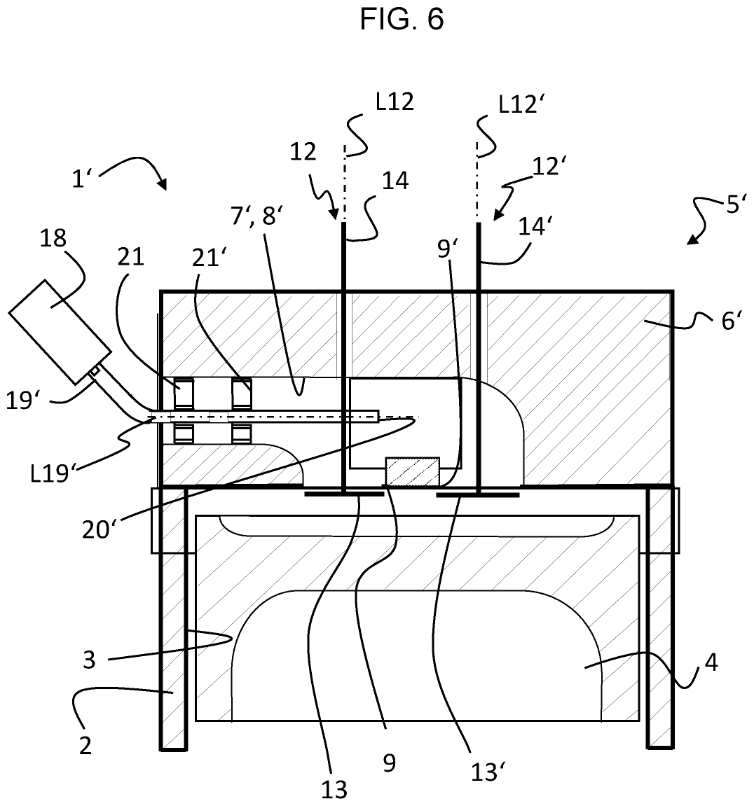

FIG. 6 shows a further design of the internal combustion engine 1′, which differs from the design of the internal combustion engine 1 in FIG. 1 in the shape of the intake port 7′. In FIG. 6, elements similar to FIG. 1 are marked with the same reference signs. In this respect, what was said above in the context of FIGS. 1 to 5 with regard to the similarities also applies analogously to the internal combustion engine in FIG. 6.

An intake port 7′ is cast into the cylinder head base element 6′. The outlet channel is not shown in FIG. 6. An air-fuel mixture can be fed into the combustion chamber 3 via the intake port 7′. The intake port 7′ is delimited by a wall 8′ and comprises a first combustion chamber inlet aperture 9 and a second combustion chamber inlet aperture 9′, which open in the direction of the combustion chamber 3.

The first combustion chamber inlet aperture 9 can be selectively opened or closed in a known manner by an inlet valve 12. For this purpose, the first inlet valve 12 comprises an inlet valve disc 13, which is arranged in a valve seat of the first combustion chamber inlet aperture 9 when the first combustion chamber inlet aperture 9 is to be closed, and an inlet valve shaft 14, which extends substantially cylindrically along a valve axis L12. The first inlet valve 12 can be moved along the first valve axis L12 by a corresponding valve train, which is arranged above the cylinder head base element 6.

The second combustion chamber inlet aperture 9′ can be selectively opened or closed in a known manner by a second inlet valve 12′. For this purpose, the second inlet valve 12′ comprises an inlet valve disc 13′, which is arranged in a valve seat of the second combustion chamber inlet aperture 9′ when the second combustion chamber inlet aperture 9′ is to be closed, and an inlet valve shaft 14′, which extends substantially cylindrically along a second valve axis L12′. The second inlet valve 12′ can be moved along the second valve axis L12′ by the valve train.

The injection aperture 20′ of the injection tube 19′ is arranged between a first imaginary plane, which is described by the first valve axis L12 and a perpendicular to the tube core axis L19′, and a second imaginary plane, in which the second valve axis L12′ is arranged and which extends parallel to the first imaginary plane.

### LIST OF REFERENCE SIGNS

1 Internal combustion engine
2 Crankcase
3 Combustion chamber
4 Piston
5 Cylinder head
6 Cylinder head base element
7 Intake port
8 Wall
9 Combustion chamber inlet aperture
8 Exhaust port
11 Combustion chamber exhaust aperture
12 Inlet valve
13 Inlet valve disc
14 Inlet valve shaft
15 Exhaust valve
16 Exhaust valve disc
17 Exhaust valve shaft
18 Injector
19 Injection tube
16 Injection aperture
21 Attachment element
22 First connecting portion
23 Second connecting portion
24 Air guiding portion
25 Air guiding portion
26 Air guiding portion
27 Air guiding portion
L19 Tube core axis
L12 Valve axis
L15 Valve axis

What is claimed is:

1. A cylinder head for an internal combustion engine comprising:
a cylinder head arrangement including an intake port;
an injector connected to the cylinder head arrangement;
a tubular injection tube, which extends along a tubular core axis into the intake port and is fluidly connected to the injector; and
an attachment element arranged on the injection tube, the attachment element having an air guiding portion which extends radially outwards with respect to the tubular core axis in such a way that a flow in the intake port is influenced by the air guiding portion.

2. The cylinder head according to claim 1, wherein a radial extension of the air guiding portion with respect to the tubular core axis is greater than an axial extension.

3. The cylinder head according to claim 1, wherein the attachment element has a first connecting portion,
wherein the attachment element is arranged on the injection tube,
wherein the air guiding portion extends from the first connecting portion radially outwards with respect to the tubular core axis.

4. The cylinder head according to claim 3, wherein a smallest cylindrical envelope of the first connecting portion, whose cylindrical axis is arranged coaxially to the tubular core axis, has a smaller radius than a largest radial extension of the air guiding portion from the tubular core axis.

5. The cylinder head according to claim 3, wherein the attachment element has a second connecting portion which is in contact with a wall of the intake port,
wherein the first connecting portion and the second connecting portion are connected to one another via the air guiding portion.

6. The cylinder head according to claim 1, wherein the injection tube has an injection aperture which opens into the intake port,
wherein the attachment element is arranged between the injector and the injection aperture.

7. The cylinder head according to claim 6, wherein the cylinder head comprises a first valve which can reversibly open and close a first combustion chamber opening of the intake port,
wherein the first valve has a valve disc and a valve shaft which extends along a first valve axis, wherein the injection aperture is arranged at least in portions within a smallest cylindrical envelope of the valve disc of the first valve which is coaxial with the first valve axis.

8. The cylinder head according to claim 6, comprising:
a first valve which can reversibly open and close a first combustion chamber inlet aperture of the intake port,
wherein the first valve has a valve disc and a valve shaft which extends along a first valve axis and in that the cylinder head comprises a second valve which can reversibly open and close a second combustion chamber inlet aperture of the intake port, wherein the second valve has a valve disc and a valve shaft which extends along a second valve axis,
wherein the injection aperture is arranged between a first imaginary plane, which is described by the first valve axis and a perpendicular to the tubular core axis; and
a second imaginary plane, in which the second valve axis is arranged and which extends parallel to the first imaginary plane.

9. The cylinder head according to claim 1, wherein the air guiding portion is formed as an air guiding baffle,
wherein an extent of the air guiding baffle along a circumference around the tubular core axis is smaller than a radial extent with respect to the tubular core axis.

10. An internal combustion engine comprising:
the cylinder head according to claim 1.
